(19) United States
(12) Patent Application Publication
(10) Pub. No.: US 2006/0289524 A1
(43) Pub. Date: Dec. 28, 2006

(54) Microwavable, sealable food/vegetable draining storage container, also known as the ''Old Maid catcher popcorn bowl"

(76) Inventors: Kathleen C Ludwig, (US); John L Zortman, (US)

Correspondence Address: Kathleen Clara Ludwig and John Lyle Zortman, Building 14 Unit D, 11250 Florence Street, Henderson, CO, 80640, US

(21) Appl. No.: 11/447,542

(22) Filed: Jun. 6, 2006

Related U.S. Application Data
(60) Provisional application No. 60/687,888, filed on Jun. 7, 2005.

(51) Int. Cl. H05B 6/80

(52) U.S. Cl. 219/734

(57) ABSTRACT

A sealable, microwavable food container for draining and storing washable goods such as salads and vegetables which includes a main storage chamber dimensioned to accept the washable goods of interest, a reservoir positioned beneath the storage chamber and an easily removable filter positioned above the reservoir and connected to the storage chamber through a series of apertures. When the user shakes the sealed container, the excess water is driven down away from the washable goods through the filter into the reservoir. The container may also be used, in likewise manner, for filtering seeds such as kernels of popcorn that have not popped from the other popped kernels.

### BACKGROUND OF THE INVENTION

This invention relates to the devices for draining and storing washable goods and, more particularly, to devices for removing excess water from salads and vegetables and storing them. This invention will also aid in removing popcorn seeds that have not popped after cooking. After rinsing the washable goods, the excess water is removed by shaking the container, or letting it stand, subjecting the contents to gravity. The same procedure is applicable to popcorn seeds that have not popped. After shaking or moving the container in a rolling fashion, the majority of unpopped kernels will be removed and collected in the bottom reservoir area of the container. The outer lip of the filtering aperture apparatus is designed to hold any seeds or un-popped kernels in the bottom reservoir area when tipped for emptying the contents left in the chamber of the container. Thereby, removing or separating the majority of un-popped kernels or seeds that have not popped from the bulk of the cooked popcorn.

The storage of vegetables and fruit or popcorn in an air-tight environment is also desirable to maintain their freshness. It would be desirable to have a device which drains excess water from washable goods and which stores them in the same airtight container. Also, it would be desirable to have a device which collects the seeds that have not popped, aka “Old Maids”, from the kernels which have popped. The same container would store the popcorn in an airtight re-sealable container.

The benefits of this product are many. One common problem is individuals breaking or cracking their teeth on uncooked or un-popped popcorn kernels, aka “Old Maids”, may be somewhat resolved simply by using this product. Another area of interest is the common practice of individuals using popcorn as part of a food constituent referred to as a snack, whereby popcorn is mixed with other foods for consumption. It may also be used to treat food products or popcorn with dressings or spices whereby the excess dressings or spices are collected in the reservoir area after passing through the apertures and thereby not relegating the food products to remain in the collecting fluids. This would help maintain freshness and, in some cases, regulate the caloric content pertaining to the dressings of the foods being treated as such. There is also partial resolution to the problem of cooked popcorn husks embarrassingly and inconveniently and painfully sticking to an individual's teeth or gums or under dental devices as these husks will accumulate in the reservoir area of the container and decrease the probability of this problematic food substance.

### BRIEF SUMMARY OF THE INVENTION

The Microwavable, sealable food/vegetable draining storage container, also known as the “Old Maid Catcher Popcorn Bowl” is durable, flexible clear plastic and dishwasher safe. It will not break if you drop it. It is usable by young and old as anyone can use it simply by shaking it. It is inexpensive. Therefore, most households may require multiple bowls. It has multiple uses in the household. It can be used for salads, fruits, spinach, vegetables, floral arrangements, popcorn and snacks. It will allow households to eat healthy snacks. It will help prevent cracked or broken teeth caused by un-popped kernels of popcorn. It will also help prevent the buildup of bacteria on vegetables, fruits and salads by allowing the food to not remain standing in liquids. It is great for preventing the buildup of dressings or spices on foods. It will also act as an aid for mixing multi-ingredient snacks.

### BRIEF DESCRIPTION OF THE SEVERAL VIEWS OF THE DRAWINGS

FIG. 1 is a side view of a container according to the present invention.

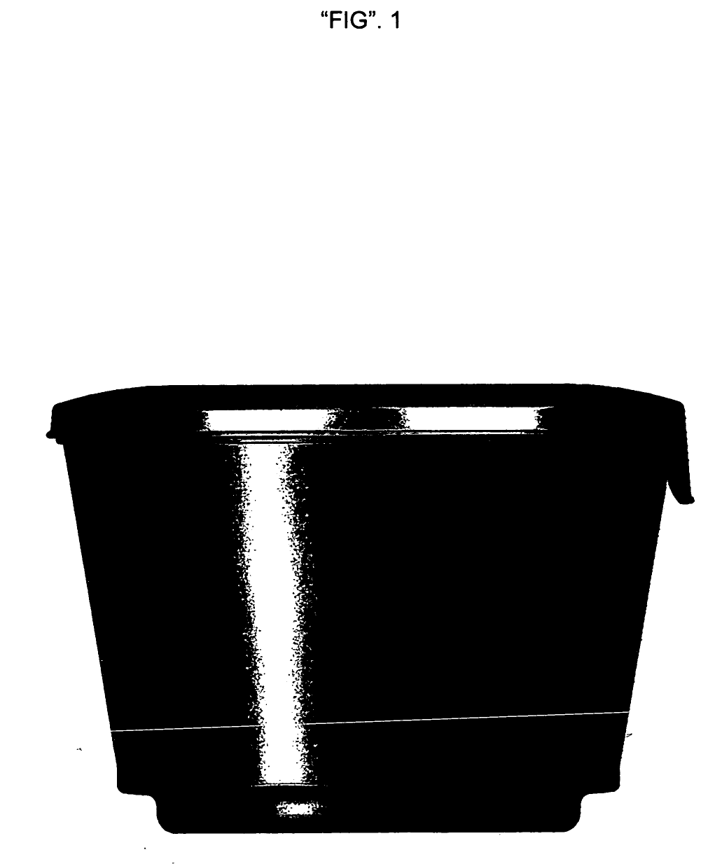

FIG. 2 is a transparent vertical cross-sectional detail top/side view showing filter with central knob for filter removal of a container according to the present invention.

FIG. 3 is a transparent vertical cross-sectional detail top/side view showing filter with side catch for filter removal of a container according to the present invention.

FIG. 4 is a transparent vertical exploded detail top/side view showing filter with side catch for filter removal and lid and reservoir of a container according to the present invention.

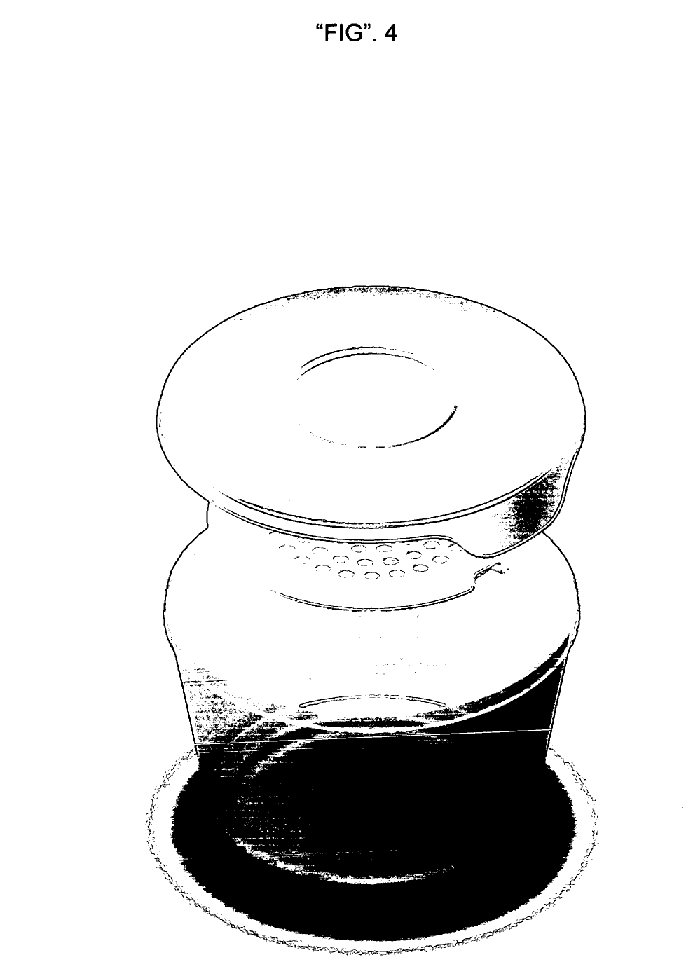

FIG. 5 is an outside transparent vertical cross-sectional detail bottom/side view of reservoir of a container according to the present invention.

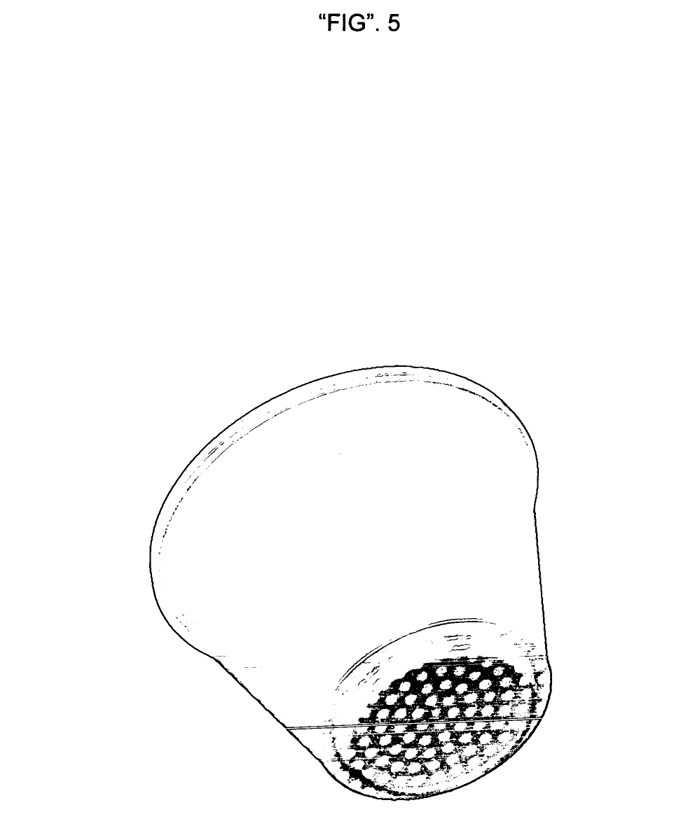

### DETAILED DESCRIPTION OF THE INVENTION

In a preferred embodiment of the invention, the container is designed for storing and draining washable goods such as salad vegetables. Also, for filtering seeds such as kernels of popcorn that have not popped from the other popped kernels. The food items are placed in the container and the container is closed using a snug lid closure fitting. The container can be stored in a refrigerator for days or weeks. The container can be removed from a refrigerator and taken along to the workplace as is. The food contents can then be heated at work, if desired, in a conventional microwave oven. The food can be eaten, and the container re-sealed for washing and reuse.

The container can be of various shapes and sizes, such as, low and flat or relatively tall and slender. The container is designed to have a mouth large enough to facilitate the removal and storage of solid food and to prevent the spilling over of boiling liquids. The container may have one or more handles thereon, or may have one or more pouring spout(s) formed thereon. All pieces are microwave and dishwasher safe.

The container, lid and filter are preferably made of any of a number of well known organic polymeric thermoplastic materials, but may also be a composite of a thermoplastic polymer and a strengthening material, such as fiberglass, carbon-fiber, etc. Moreover, the container, lid and filter may be either a natural or a synthetic resin. The function of the container, lid and filter is to be flexible at room temperature and thermally stable over a temperature range extending from minus ten degrees Fahrenheit to two hundred thirty degrees Fahrenheit and thus prevent breakage and insure durability. In addition, this thermal stability range will help ensure the container, lid and filter components do not warp or crack when subjected to repeated heating and cooling. Moreover, the container, lid and filter have a high resistance to discoloration or aging even after extended use. Plastics such as polyethylene (LDPE to HDPE) and polypropylene can be used, as well as polycarbonates, polyester, nylon, and blends of any of these, because the temperatures in a microwave do not rise very high when compared to a conventional oven.

All of the container, lid and filter components are microwave transmissive, and allow the food contained within to be heated by microwave energy. In the context of this specification, the term, “microwave transmitting material” is taken to include common glasses, ceramics and plastics.

In the preferred embodiments of the invention, the vessel and its related components are strong enough and thick enough to be treated as free-standing vessels and components. This condition may be satisfied by a plastic vessel having a thickness of one or more millimeters. Thus, one approach to making a food container in the preferred embodiment of this invention is to select the sizes of the container, lid and filter of this free-standing vessel and components so all individual pieces can both fit snugly when in use, and can easily be separated to be cleaned and dried and subsequently re-assembled to form the preferred embodiment or this invention.

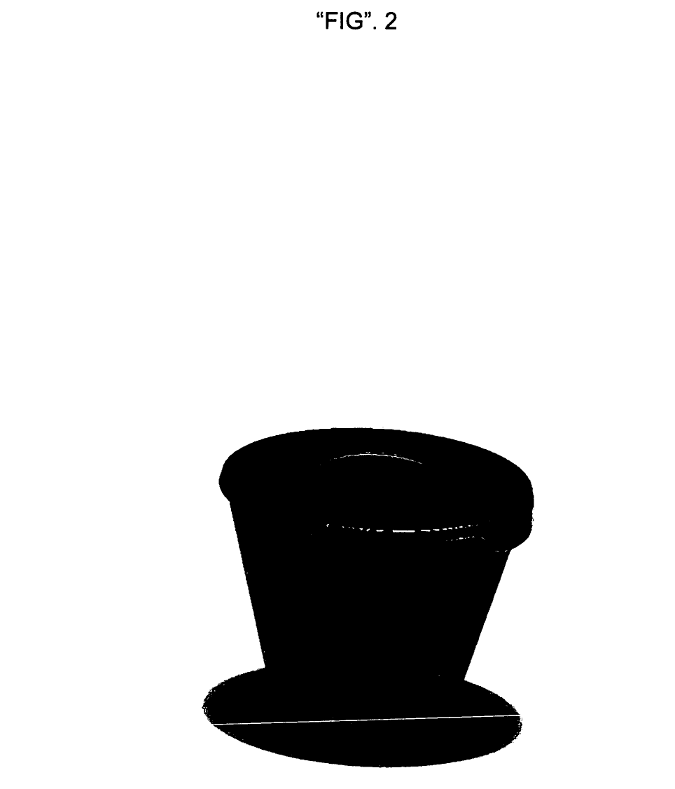

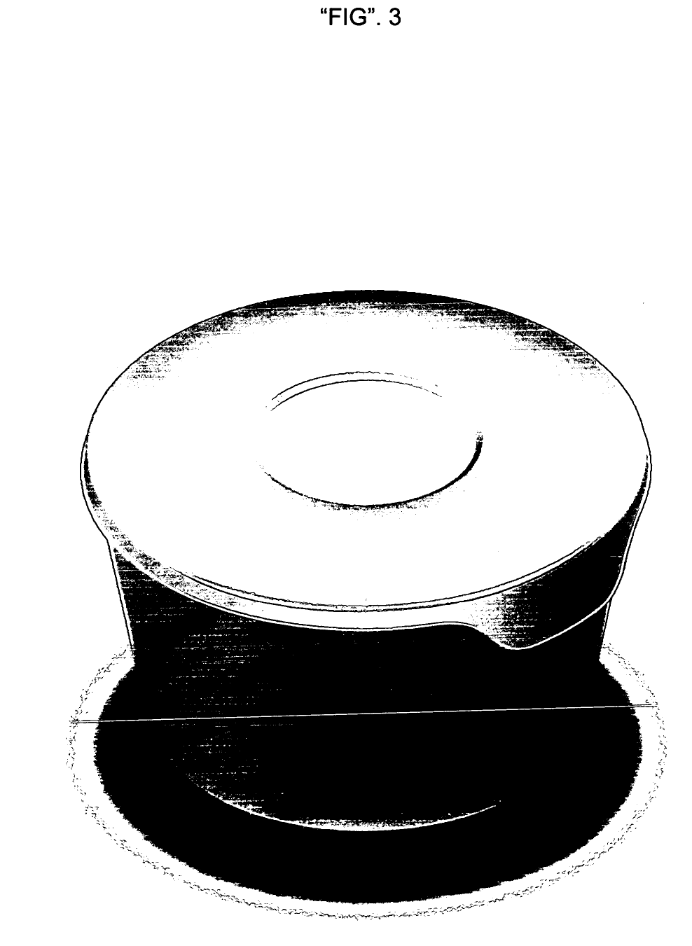

In the preferred embodiments of the invention, the filter component has a device to facilitate its removal once it has been inserted into position above the reservoir and below the chamber area of the container. Among these devices, but not limited to their explanation or determination is a tab extending upwardly and circumferentially from its center from the filter for easy removal of the filter as depicted in FIG. 2. This device can take various forms and locations as may be depicted in FIG. 3. that shows a finger tab located on the exterior rim of the filter for example. In the preferred embodiments of the invention, the inner chamber of the container may have a protrusion taking various forms and may be, but not limited to, a snap-in feature. It is located at the mouth of the reservoir.

There are also many approaches for providing a lid to seal the mouth of the food container. As depicted in FIG. 3, a lid can engage an outwardly extending lip of the chamber portion of the container. The lid will fit snugly so as to seal the container. The lid will have an extrusion as in, but not limited to FIG. 2, to facilitate its removal.

With respect to the above description then, it is to be realized that the optimum dimensional relationships for the parts of the invention, to include variations in size, materials, shape, form, function and manner of operation, assembly and use are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, because numerous modifications and changes will readily occur to those skilled in the art, it is not desired to limit the invention to the exact construction and operation shown and described, and accordingly all suitable modifications and equivalents may be resorted to, falling within the scope of the invention.

What is claimed is:

1. A micro-wave safe container comprising, in combination: a reservoir, a removable filter above the reservoir with the same circumference as the chamber bottom, the chamber has tabs to hold the removable filter, a releasable sealing lid for engaging an upwardly extending lip portion of the outer chamber.

2. The food container of claim 1 wherein the plastic vessel is flexible at room temperature.

3. The food container of claim 1 wherein the plastic vessel is thermally stable over a temperature range extending from minus ten degrees Fahrenheit to two hundred thirty degrees Fahrenheit.

4. The food container of claim 1 comprising, in combination: a snap in filter, an easily removable filter positioned above the reservoir and connected to the storage chamber through a series of apertures, a tab extending upwardly and circumferentially from the middle of the filter for easy removal from the chamber. This device can take various forms and locations.

5. A microwave-safe food container comprising, in combination: a free standing plastic outer vessel having a bottom and at least one side wall extending upwardly and circumferentially about the bottom to a selected height above the bottom.

6. The food container of claim 4 comprises a mouth portion that is at least two inches in diameter.

7. The food container of claim 4 further comprises a lid so as to seal the container.

8. The food container of claim 4 wherein the plastic vessel is thermally stable over a temperature range extending from minus ten degrees Fahrenheit to two hundred thirty degrees Fahrenheit.

9. The food container of claim 4 comprises a reservoir having a bottom and at least one side wall extending upwardly and circumferentially to a selected height.

10. The food container of claim 4 comprises a reservoir circumferentially smaller than the chamber.

11. The food container of claim 4 comprises a chamber extending upwardly and circumferentially wider above the reservoir.
